(19) United States
(12) Patent Application Publication
(10) Pub. No.: US 2008/0135337 A1
(43) Pub. Date: Jun. 12, 2008

(54) LUBRICATION STRUCTURE OF TRANSMISSION

(75) Inventor: Mitsugu KAWAMOTO, Nishio-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI Co., Ltd., Nishio-shi (JP)

(21) Appl. No.: 11/936,030

(22) Filed: Nov. 6, 2007

(30) Foreign Application Priority Data
Nov. 7, 2006 (JP) 2006-301598

(51) Int. Cl. F16H 57/04

(52) U.S. Cl. 184/6.12

(57) ABSTRACT

A lubrication structure of a transmission includes an input shaft an output shaft including one end coaxially inserted with the input shaft and another end formed with an engagement portion, a first bearing member fitted between the input shaft and the output shaft, a second bearing member fitted between the output shaft and the housing, a shaft member including an end portion inserted into and engaged with the engagement portion of the output shaft, a lubricant passage including a first passage portion formed between the output shaft and the housing, a second passage portion formed between the output shaft and the shaft member, and an inner passage axially formed at an inner portion of the output shaft and reaching the first bearing member for guiding lubricant to the first bearing member, and a branched passage formed at the housing and branched from a vertically intermediate portion of the lubricant passage.

### CROSS REFERENCE TO RELATED APPLICATIONS

This application is based on and claims priority under 35 U.S.C. § 119 to Japanese Patent Application 2006-301598, filled on Nov. 7, 2006, the entire content of which is incorporated herein by reference.

### FIELD OF THE INVENTION

This invention generally relates to a lubrication structure of a transmission for a vehicle, and in particular to a lubrication structure for a bearing member fitted between an input shaft and an output shaft of the transmission, the input shaft and the output shaft which are coaxially arranged.

### BACKGROUND

As one of transmissions for a vehicle, a gear-engaging type transmission, which includes a plurality of shaft members and gear sets respectively provided at the shaft members and engaged therewith, and which selects one of the gear sets by an actuator operation or a manual operation so as to establish a predetermined gear ratio in the transmission, has been proposed. In such type of transmission, a lubrication structure is generally employed, the lubrication structure in which lubricant is contained in a fluid-tight manner and circulated in a housing, so as to achieve smooth movements of bearing portions and engagement portions and to control a functional depression due to abrasion by reducing temperature rise caused by frictional heat. In addition, as a method for circulating and supplying the lubricant, an oil lifting system and an oil receiver system are broadly employed. In the oil lifting system, the lubricant accumulated in a lower portion of the housing is lifted up and scattered out by use of centrifugal force due to rotations of gears and accordingly, the lubricant is supplied to portions to be lubricated. In addition, in the oil receiver system, the lifted up lubricant is gathered by a plate-shaped oil receiver provided at an upper space in the housing and then, the lubricant is guided to lubrication-target members through a lubricant passage.

In order to downsize the transmission of the vehicle, recent requirements have lead to providing a structure, in which an input shaft and an output shaft are coaxially arranged by inserting one into the other and a relative rotation of the too shafts are allowed by fitting bearing members between an outer shaft from among the two shafts and the housing and between, the two shafts. In order to stably supply the lubricant to the bearing members in such coaxial arrangement structure, various inventions, in which changes of rotational speed of shafts and structural limitations are considered, are produced. As one of the examples, a lubrication apparatus of a transmission is disclosed in Japanese Patent Publication No. 2003-185001A hereinafter, referred to as reference 1) filed by an applicant of the present application. The lubrication apparatus of the transmission disclosed in the reference 1 includes a separator, an oil accumulator and an oil catcher, for guiding lubricant supplied to a support bearing member arranged between a housing and an output shaft, to an inter-shaft bearing member arranged between the output shaft and an input shaft through an oil bore. Such members effectively guide the lubricant without leaking the same, and absorbs and stabilizes a time-fluctuation of an amount of the lubricant supplied.

According to the lubricating apparatus disclosed in reference 1, the lubricant is guided to the inter-shaft bearing member arranged between the output shaft and the input shaft. However, the lubricant may be excessively supplied to the inter-shaft bearing member. Lubrication-target members, such as gears, which are exposed to a housing space, may not be supplied with an excessive amount of lubricant. On the other hand, with respect to the lubrication target members, such as inter-shaft bearing member, arranged in a closed space, when an amount of the lubricant is excessive, the excessive amount of the lubricant may remain in the oil bore and/or the oil passage. Accordingly, there may be a possibility that a characteristic of the lubrication apparatus is degraded due to temperature rise. As a remedy for such possibility, an oil drain passage for draining the lubricant may be provided in the oil bore and the oil passage. However, there may be a possibility that the amount of lubricant supply may be insufficient. Accordingly, it is preferable for the amount of the lubricant supplied to the inter-shaft bearing member to be adequate, i.e. not to be excessive nor insufficient.

In addition, the transmission includes many components structured intricately. Therefore, in a case where each of plural lubrication-target members arranged in the closed space is provided with the oil passage, a lubrication structure play be complicated. Accordingly, a lubrication structure, in which the plural lubrication-target members are connected by the oil passage to be in line or in parallel for guiding the lubricant, may be considered to be effective and simple, and may be preferable. For example, in the lubrication structure, it is preferable that another lubrication-target member is lubricated as well as the support bearing member and the inter-shaft bearing member.

A need thus exists for a lubrication structure of a transmission, which is not susceptible to the drawback mentioned above.

### SUMMARY OF THE INVENTION

According to an aspect of the present invention, a lubrication structure of a transmission includes a housing, an input shaft, an output shaft, a first bearing member, a second bearing member, a shaft member, a lubricant passage and a branched passage. The input shaft is inputted with the rotational force. The output shaft is coaxially arranged with the input shaft and includes one end inserted with an end portion of the input shaft and another end formed with an engagement portion at an inner periphery the engagement portion which outputs the rotational force. The first bearing member is fitted between the input shaft and the output shaft for allowing a relative rotation between the input shaft and the output shaft. The second bearing member is fitted between the output shaft and the housing for rotatably supporting the output shaft. The shaft member is rotatably supported by the housing and includes an end portion inserted into and engaged with the engagement portion of the output shaft. The lubricant passage includes a first passage portion formed between the output shaft and the housing, a second passage portion formed between the output shaft and the shaft member, and an inner passage formed at an inner portion of the output shaft and extending in the axial direction. Further, the lubricant passage reaches the first bearing member for guiding lubricant to the bearing member. The branched passage is formed at the housing and branched from a vertically intermediate portion of the lubricant passage.

### BRIEF DESCRIPTION OF THE DRAWINGS

The foregoing and additional features and characteristics of the present invention voile become more apparent from the following detailed description considered with reference to the accompanying drawings, wherein:

FIG. 1 is a cross-sectional side view illustrating a lubrication structure according to an embodiment of the present invention;

FIG. 2A is a front view illustrating a cover member of the lubrication structure, seen from a left side in FIG. 1, according to the embodiment of the present invention; and

FIG. 2B is a cross sectional view illustrating the cover member, of the lubrication structure, taken along the line IIB-IIB shown in FIG. 2A, according to the embodiment of the present invention.

### DETAILED DESCRIPTION

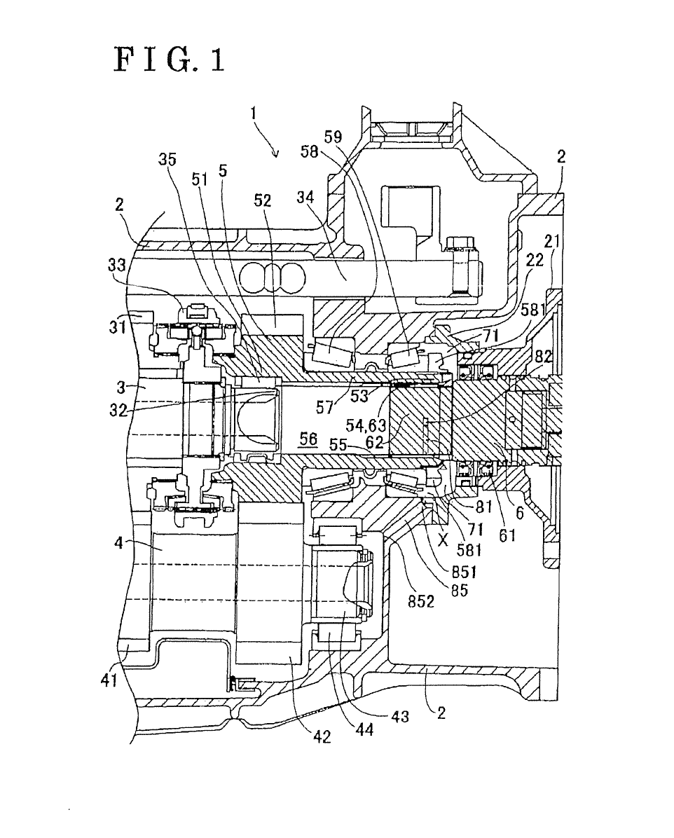

An embodiment of the present invention will be described hereinafter with reference to attached drawings. FIG. 1 is a cross-sectional side view of a transmission, the cross-sectional side view illustrating a lubrication structure according to the embodiment of the present invention. The lubrication structure, generally indicated by reference numeral 1, is principally structured with a housing 2, an input shaft 3, a counter shaft 4, an output shaft 5, and a transfer shaft 6. An appropriate amount of lubricant is contained in the housing 2 in a fluid-tight manner and is used by being circulated by means of members such as an oil receiver, which is not illustrated in the drawings. Directions, such as “axial” (left and right), “vertical” (upper and lower) or the like, which are mentioned herein, correspond to an orientation of the transmission illustrated in FIG. 1.

The input shaft 3 is mounted with a plurality of driving gears 31 (only one is illustrated in the drawing). The input shaft 3 is inputted with a rotational force from the left direction in FIG. 1 and is axially supported thereat. An end portion 32, located at the right side of the input shaft 3, is inserted into one end 51 of the output shaft 5, one end 51 which is located at the left side of the output shaft 5. The counter shaft 4 is provided at a lower space, of the housing 2, relative to the input shaft 3 and is arranged to be in parallel with the input shaft 3. The counter shaft 4 is mounted with a plurality of driven gears 41 (only one is illustrated in the drawing). Each driven gear 41 and the corresponding driving gear 31 are engaged with each other and structure a gear set for establishing a predetermined gear ratio. In addition, the counter shaft 4 includes an output-driving gear 42 at its right portion as shown in FIG. 1. In addition, all end portion 43, located at the right side of the output-driving gear 42, is axially supported to the housing 2 by means of a bearing portion 44. A synchromesh mechanism 33 is provided on the input shaft 3 and implements a selection of the gear set for transmitting the rotational force. The synchromesh mechanism 33 is structured to be operated by an operating mechanism 34 arranged at an upper space of the housing 2. Additionally, the driven gears 41 and the output-driving gears 42, which are provided on the counter shaft 4, are structured to lift up the lubricant accumulated in a lower portion of the housing 2.

The output shaft 5 is a hollow and approximately cylindrical member and is coaxially arranged with the input shaft 3. The output shaft 5 is inserted with the end portion 32 of the input shaft 3 at an inner periphery of the end 51 of the output shaft 5 in a manner that the output shaft 5 is coaxial with the input shaft 3. The output shaft 5 is mounted with an output-driven gear 52 at the outer peripheral portion of the end 51 of the output shaft 5. The output-driven gear 52 is generally engaged with the output-driving gear 42 provided on the counter shaft 4. An inner periphery of the other end 53 of the output shaft 5 is formed with an engagement portion outputting the rotational force. According to the embodiment of the present invention, spline-engagement grooves 54 (serving as a groove of the output shaft) is axially formed at the inner periphery of the other end 53 of the output shaft 5 as the engagement portion. In addition, a lubricant groove 55 (serving as a second passage portion) is formed in parallel with the spline-engagement groove 54 so as not to interfere therewith. Further, a hollow portion of the output shaft 5 along the axis serves as an inner passage 56. The inner passage 56 is formed at an inner portion of the output shaft 5, i.e., at the hollow portion of the output shaft 5, and extends in the axial direction and is structured to continuously communicate with the end 51, the lubricant groove 55 and the other end 53 of the outer shaft 5.

A pilot bearing 35 serves as a first bearing member and is fitted between the end portion 32 of the input shaft 3 and the end 51 of the output shaft 5. The pilot bearing 35 is configured by a roller bearing and allows a relative rotation between the input shaft 3 and the output shaft 5. A pair of tapered roller bearings 58 and 59 serves as a second bearing member and is fitted between the housing 2 and an outer periphery of an axially approximate central portion 57 of the output shaft 5 for rotatably supporting the output shaft 5. The tapered roller bearings 58 and 59 are assembled by being press-fitted by nuts 581 from the right side as shown in FIG. 1, and holds the output shaft 5 to be rotatable.

The transfer shaft 6 serves as a shaft member and is supported to a transfer housing 21 to be relatively rotatable by means of a bearing portion 61. Spline-engagement grooves 63 are formed at an outer periphery of an end portion 62 of the transfer shaft 6, an end portion 62 which is located at the left portion of the transfer shaft 6. The end portion 62 of the transfer shaft 6 is inserted into the other end 53 of the output shaft 5. Additionally; the spline-engagement groove 63 formed at the end portion 62 of the transfer shaft 6 and the spline-engagement groove 54 of the output shaft 5 are engaged and connected with one another, thus the rotational force is transmitted.

Additionally, an approximate ring-shaped cover member 22 is provided between the housing 2 and the transfer housing 21 and seals therebetween. The cover member 22 and the transfer housing 21 are included in the housing 2.

Next, a structure of a lubricant passage, which is formed by utilizing a space between the above described components, and which includes an lubricant passage space 71 (serving as a first passage portion), the lubricant groove 55 (serving as the second passage portion) of the output shaft 5, and the inner passage 56 of the output shaft 5, will be described hereinafter in detail with reference to FIG. 1. An oil passage (not illustrated) is formed between an oil receiver, which is not illustrated and serves as a supply source of the lubricant, and the tapered roller bearings 58 and 59. A space between the tapered roller bearings 58 and 59 continuously communicates with the lubricant passage space 71 formed between the output shaft 5 and the housing 2. More specifically, with reference to FIG. 1, the lubricant passage space 71 is an axially symmetrical space surrounded by the other end 53 of the output shaft 5, the nuts 581, the housing 2, the cover member 22 and an axially left end of the transfer cover 21. The lubricant passage space 71 communicates with an axially right portion of the lubricant groove 55 formed between the output shaft 5 and the transfer shaft 6, and a left portion of the lubricant groove 55 communicates with the inner passage 56 of the output shaft 5. In addition, the inner passage 56 reaches the pilot bearing 35 arranged at the left portion of the output shaft 5. As described above, a closed route is structured from the oil receiver to the pilot bearing 35 through the tapered roller bearing 58, 59, the lubricant passage space 71, the lubricant groove 55 and the inner passage 56, and the closed route serves as the lubricant passage. That is, the lubricant passage includes the oil passage (not illustrated) formed between the oil receiver and the tapered roller bearings 58, 59, the lubricant passage space 71 formed between the output shaft 5 and the housing 2, the lubricant groove 55 of the output shaft 5, and an oil passage between the inner passage and the pilot bearing 35, which all are formed in a fluidly communicated manner. The lubricant passage is closed and the tapered roller bearing 58, 59 and the pilot bearing 35 are lubricated by the lubricant flowing in the lubricant passage. Additionally, the lubricant passage may include at least one of the spline-engagement groove 54 formed at the output shaft 5 and the spline-engagement groove 63 formed at the transfer shaft 6.

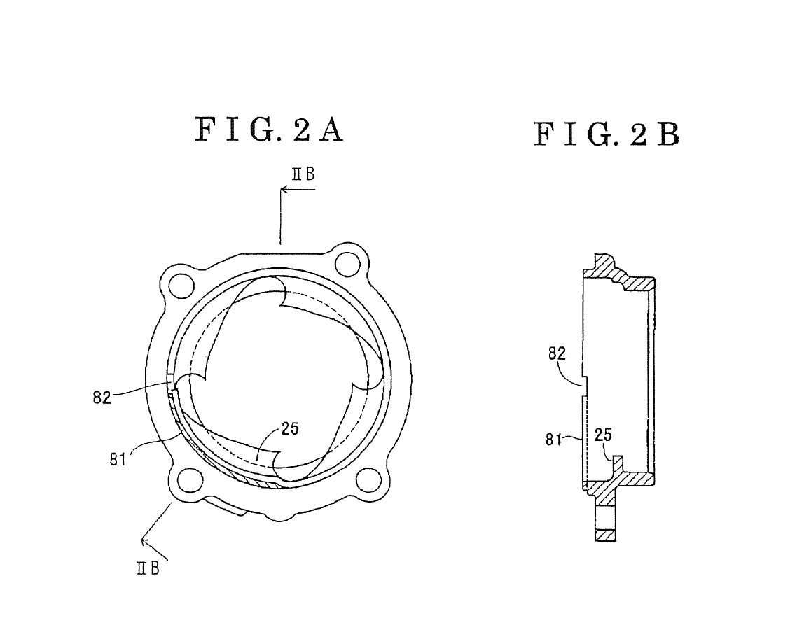

A branched passage is formed at the housing 2 and branched from a vertically intermediate portion of the lubricant passage. More specifically, the branched passage is structured for guiding the lubricant to the bearing portion 44 of the counter shaft 4 and configured with a branched groove portion 81 formed at the cover member 22 and a counter shaft groove portion 85 formed at the housing 2. FIG. 2A is a front view illustrating the cover member 22 seen from the axially left side in FIG. 1. FIG. 2B is a cross sectional view illustrating the cover member 22 taken along the line IIB-IIB shown in FIG. 2A. As illustrated therein, the cover member 22 is an approximately annular shaped member. A rim of the cover member 22 is cut out at an intermediate height, i.e., at a vertically intermediate portion, and a branched opening 82 (a recess) is formed. In addition, the branched groove portion 81 (hatched in FIG. 2A) is formed by cutting the rim of the cover member 22 continuously from the branched opening 82 towards a lower portion of the cover member 22. Here, as illustrated in FIG. 1, the cover member 22 is integrally provided with the housing 2. Thus, as illustrated in FIG. 1, the branched opening 82 is opened at an intermediate height of an inner peripheral portion of a back surface of the cover member 22 relative to the lubricant passage space 71, and the branched groove portion 81 is structured to be a hollow passage extending towards the lower portion of the cover member 22. On the other hand, the counter shaft groove portion 85 is formed at the housing 2. An upper end 851 of the counter shaft groove portion 85 communicates with die branched groove portion 81, and a lower end 852 of the counter shaft groove portion 85 is opened to the bearing portion 44 of the counter shaft 4.

As is apparent from FIG. 2A, the cover member 22 is formed with a guide member 25. The guide member 25 curves towards the rim and then, aims to an axial center by sequentially changing its curving direction, and the guide member 25 guides the lubricant. In other words, the guide member 25 is employed for guiding the lubricant to a direction of the axial center, the lubricant which is forced by the output shaft 5 and turning in the lubricant passage space 71.

Next, an actuation and an operation of the lubrication structure 1 according to the above-described embodiment will be described hereinafter. When the transmission is started, a rotational force inputted to the input shaft 3 is transmitted in an order from the driving gears 31 of the input shaft 3, the driven gears 41 of the counter shaft 4, the output-driving gear 42 of the counter shaft 4, the output-driven gear 52 of the output shaft 5, the spline-engagement groove 54 of the output shaft 5, and to the spline-engagement groove 63 of the transfer shaft 6. In the mean time, the lubricant accumulated in the lower portion of the housing 2 is lifted up by the driven gears 41 and the output-driving gear 42, of the counter shaft 4, and accumulated in the oil receiver (not illustrated). The lubricant accumulated in the oil receiver (not illustrated) is guided to the tapered roller bearings 58, 59 through the oil passage (not illustrated) and lubricates the tapered roller bearings 58, 59. Next, the lubricant enters into the lubricant passage space 71. Then, the lubricant is forced to be rotated by the output shaft 5 rotating and passes through the lubricant groove 55 of the output shaft 5. Further, the lubricant reaches the pilot bearing 35 through the inner passage 56 and the pilot bearing 35 is lubricated. Then, the lubricant returns to the lower portion of the housing 2. In addition, the lubricant rotated is partially separated from the branched opening 82. The partially separated 110 lubricant is guided to the bearing portion 44 of the counter shaft 4 through the branched groove portion 81 and the counter shaft groove portion 85, and lubricates the bearing portion 44 of the counter shaft 4. Thus, the lubricant passage communicates with the tapered roller bearings 58, 59. In addition, the branched passage communicates with other components to be lubricated, such as the bearing portion 44 of the counter shaft 4, and guides the lubricant to such components.

When an operation of the transmission is continued, the lubricant is gradually accumulated in the lubricant passage space 71, and a lubricant surface is elevated. Then, when the lubricant surface reaches the branched opening 82, an excessive lubricant is separated from the branched opening 82 and the bearing portion 44 of the countershaft 4 is lubricated. If the branched opening 82 is provided at a bottom portion X of the lubricant passage space 71, the lubricant is hardly accumulated in the lubricant passage space 71 and an amount of supply of the lubricant to the pilot bearing 35 may be insufficient. On the other hand, an amount of the supply of the lubricant to the bearing portion 44 of the counter shaft 4 may be excessive. Thus, an unbalance of the amount of lubricant supplied to such members is caused.

Consequently, according to the lubrication structure 1 of the embodiment, the tapered roller bearings 58, 59, the pilot bearing 35, the bearing portion 44 of the counter shaft 4 can be lubricated together. In addition, an amount of the lubricant accumulated in the lubricant passage space 71, which is provided at the right side of the pilot bearing 35 and through which the lubricant passes before reaching the pilot bearing 35, can be kept to be appropriate, i.e. to be equal to or lower than the intermediate height of the cover member 22, where the branched opening 82 is provided. Accordingly, the excessive amount of the lubricant is prevented from remaining at the lubricant passage and other components.

According to the above described embodiment, the input shaft 3 and the output shaft 5 are members inputted with and outputting the rotational force. Further, the input shaft 3 and the output shaft 5 are coaxially arranged by inserting the end portion 32 of the input shaft 3 into the end 51 of the output shaft 5. Still further, the counter shaft 4 are provided to be in parallel with the input shaft 3 and the output shaft 5. Then, the plural gear sets with different gear ratio axe properly mounted on the input shaft 3 and the counter shaft 4 so as to transmit the rotational force from the input shaft 3 to the output shaft 5 via the counter shaft 4. Accordingly, the input shaft 3 and the output shaft 5 relatively rotate with rotational speed being different from that of one another.

Further according to the above described embodiment, the pilot bearing member 35 serving as the first bearing member is fitted between the end portion 32 of the input shaft 3 and the end 51 of the output shaft 5 so as to allow the relative rotation between the input shaft 3 and the output shaft 5. Further, the tapered roller bearings 58 and 59 serving as the second bearing member are fitted between the housing 2 and the output shaft 5 for rotatably supporting the output shaft 5. In addition, the inner periphery of the other end 53 of the output shaft 5 is formed with the engagement portion such as the spline-engagement grooves 54 so that the output shaft 5 is engaged with the transfer shaft 6. Still in addition, the inner portion of the output shaft 5 is hollow and is formed with the inner passage 56 associating the pilot bearing member 35 provided at the end 51 with the engagement portion (the spline-engagement grooves 54) formed at the other end 53 of the output shaft.

The transfer shaft 6 is a member transmitted with the rotational force of the output shaft 5 and for example serving as a shaft of a transfer device employed for being connected to the transmission for the vehicle. The transfer shaft 6 is supported to the housing 2 (the transfer housing 21) to be relatively rotatable. Additionally, the spline-engagement grooves 63 are formed at the outer periphery of the end portion 65 of the transfer shaft 6 so as to be inserted into and engaged with the spline-engagement grooves 54 (engagement portion) of the output shaft 5.

The lubricant passage is a lubricant passage for guiding the lubricant to the pilot bearing 35. The lubricant passage is formed between the output shaft 5 and the housing 2, and between the output shaft 5 and the transfer shaft 6. Thus, the lubricant passage may be formed at a narrow cylindrical space between components, for example. In addition, the lubricant passage is structured to reach the pilot bearing 35 via the inner passage 56 of the output shaft 5. The branched passage is structured for separating the lubricant flowing through the lubricant passage towards the pilot bearing 35. The branched passage is formed at the housing 2 and branched from the vertically intermediate portion of the lubricant passage.

Due to the above described structure, the lubrication structure 1 of the transmission is operated as follows. The lubricant is supplied to the space between the output shaft 5 and the housing 2, i.e., to the lubricant passage space 71, from the oil supply source such as the oil receiver (not illustrated). Then, the lubricant is guided through the lubricant passage and reaches the pilot bearing 35, thus the pilot bearing 35 is lubricated. Immediately after the transmission is started, the lubricant is not accumulated or flowing in the lubricant passage. However, in accordance with a time, the lubricant is supplied to the lubricant passage and partially accumulated therein, thus the pilot bearing 35 is properly lubricated. When the operation of the transmission is further continued, the surface of the lubricant accumulated in the lubricant passage is elevated and reaches the vertically intermediate portion thereof, where the branched passage is formed. Then, the excessive amount of the lubricant flows from the branched passage and does not interfere the lubrication of the pilot bearing 35. Accordingly, the surface of the lubricant in the lubricant passage is kept to be appropriate, and an appropriate amount of the lubricant is supplied to the pilot bearing member 35. Thus, a characteristic of the lubrication structure 1 of the transmission may not be degraded due to the temperature rise caused by a remain of the excessive amount of the lubricant to the lubricant passage.

Additionally, if a vertical portion at which the branched opening 82 is provided is too low, the amount of the lubricant flowing from the branched passage may be increased and on the other hand, the amount of the lubricant supplied to the pilot bearing 35 may be insufficient. On the contrary, if the vertical portion at which the branched opening 82 is provided is too high, the lubricant may not be prevented from being remained in the lubricant passage. An appropriate (preferable) height of the vertical portion requires to be designed depending on a configuration of the transmission.

Further according to the embodiment of the present invention, the lubricant passage communicates with the tapered roller bearings 58, 59 serving as the second bearing member. In addition, the branched passage communicates with other components to be lubricated and guides the lubricant to the component of the lubrication structure to be lubricated.

Due to the above described structure, the lubrication structure 1 may be structured so that the lubricant supplied from the supply source such as the oil receiver (not illustrated) fluidly communicates with and lubricates the tapered roller bearings 58, 59 at first and then, lubricates the pilot bearing member 35. In addition, the branched passage may be structured for guiding the lubricant to other components to be lubricated, the other components such as the bearing portion 44 of the counter shaft, not for draining the lubricant to the housing space. Accordingly, due to the above described structure, more than two components, i.e., such as the tapered roller bearings 58, 59, the pilot bearing 35, and the bearing portion 44 of the counter shaft 4, can be lubricated by one operation of circulating and supplying the lubricant. In addition, the lubricant may not be drained without being utilized. Thus, an effective and simple lubrication structure may be provided.

Still further according to the embodiment of the present invention, the engagement portion of the output shaft 5 is axially formed with a groove such as the spline-engagement groove 54. In addition, the lubricant passage includes at least one of the spline-engagement groove 54 of the output shaft 5 and the spline-engagement groove 63 axially formed at the outer periphery of the transfer shaft 6.

With respect to the lubricant passage, the output shaft 5 is formed with the engagement portion between the output shaft 5 and the transfer shaft 6. If a groove such as the spline-engagement groove 54 is not formed at the output shaft 5 the engagement portion is not structured for guiding the lubricant. Accordingly, for guiding the lubricant to the pilot bearing 35, a groove such as the spline-engagement groove 54 may be formed at the engagement portion of the output shaft 5 in the axial direction as well as an engagement structure of the engagement portion of the output shaft 5. The groove may be formed at the inner periphery of the output shaft 5 and at the outer periphery of the transfer shaft 6. Cross-sectional area and a number of the groove may be properly modified in accordance with a required amount of the lubricant.

Still further according to the embodiment of the present invention, the housing 2 includes the cover member 22, and the branched passage is formed at the cover member 22.

Though lubricant passage can be formed at the housing 2, another process such as cutting process may be required. However, for example, the branched passage may be formed at the cover member 22, which covers the other end 53 of the output shaft 5, not at a main body of the housing 2. Due to this structure, even if the design of the lubrication structure 1 requires to be changed, portions to be changed may be limited (reduced). Further, processing operation may be easier and productivity may be increased.

According to the transmission (gear transmission) of the present invention, the branched passage is provided at the vertically intermediate portion (i.e., at the intermediate height) of the lubricant passage for guiding the lubricant to the pilot bearing 35 fitted between the input shaft 3 and the output shaft 5 of the transmission. Accordingly, the appropriate amount of the lubricant is accumulated in the lubricant passage and is supplied to the components to be lubricated. In addition, the characteristic of the lubrication structure 1 may not be degraded due to the excessive lubricant remained at the components.

Further according to the present invention, the tapered roller bearings 58, 59 and other lubrication target members, such as the bearing portion 44 of the counter shaft 4, can be lubricated together by the one operation of circulating and supplying the lubricant. Thus, the effective and simple lubrication structure may be provided.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A lubrication structure of a transmission, comprising:
a housing;
all input shaft inputted with rotational force;
an output shaft coaxially arranged with the input shaft and including one end inserted with an end portion of the input shaft and another end formed with an engagement portion at an inner periphery, the engagement portion outputting the rotational force;
a first bearing member fitted between the input shaft and the output shaft for allowing a relative rotation between the input shaft and the output shaft;
a second bearing member fitted between the output shaft and the housing for rotatably supporting the output shaft;
a shaft member rotatably supported by the housing and including an end portion inserted into and engaged with the engagement portion of the output shaft;
a lubricant passage including a first passage portion formed between the output shaft and the housing, a second passage portion formed between the output slat and the shaft member, and an inner passage formed at an inner portion of the output shaft and extending in the axial direction and reaching the first bearing member for guiding lubricant to the first bearing member; and
a branched passage formed at the housing and branched from a vertically intermediate portion of the lubricant passage.

2. A lubrication structure of a transmission according to claim 1, wherein the lubricant passage communicates with the second bearing member, and the branched passage communicates with another component of the lubrication structure to be lubricated and guides the lubricant to the component of the lubrication structure to be lubricated.

3. A lubrication structure of a transmission according to claim 1, wherein the engagement portion of the output shaft is axially formed with a groove, and the lubricant passage includes at least one of the groove of the output shaft and a groove axially formed at an outer periphery of the shaft member.

4. A lubrication structure of a transmission according to claim 2, wherein the engagement portion of the output shaft is axially formed with a groove, and the lubricant passage includes at least one of the groove of the output shat and a groove axially formed at an outer periphery of the shaft member.

5. A lubrication structure of a transmission according to claim 1, wherein the housing includes a cover member and the branched passage is formed at the cover member.

6. A lubrication structure of a transmission according to claim 2, wherein the housing includes a cover member and the branched passage is formed at the cover member.

7. A lubrication structure of a transmission according to claim 3, wherein the housing includes a coffer member and the branched passage is formed at the cover member.

8. A lubrication structure of a transmission according to claim 4, wherein the housing includes a cover member and the branched passage is formed at the cover member.
